(19) United States
(12) Patent Application Publication
(10) Pub. No.: US 2005/0030167 A1
(43) Pub. Date: Feb. 10, 2005

(54) Vehicle recovery system and method

(76) Inventor: Pual T. Potter, Falls Church, VA (US)

Correspondence Address: Paul Potter, 6434 Eppard Street, Falls Church, VA, 22044, US

(21) Appl. No.: 10/805,586

(22) Filed: Mar. 22, 2004

Related U.S. Application Data
(60) Provisional application No. 60/492,675, filed on Aug. 6, 2003.

(51) Int. Cl. B60R 25/10

(52) U.S. Cl. 340/426.1

(57) ABSTRACT

A vehicle recovery system and method are disclosed. The system and method disable a misappropriated vehicle, position and ignite a smoke flare for ready detection of the public as to the whereabouts of the vehicle and provide a recovery center service. Use of unlicensed wireless data radio spectrum is used thus avoiding the cost of maintaining a mobile phone subscription for a dedicated on-boar phone. Part of the system and method is to run a campaign to inform the public as to the significance of the flare discharge. Further the campaign also advises the public to place a call to local law enforcement agency or the recovery service agency holding out an incentive to do so.

### CROSS REFERENCE TO RELATED APPLICATIONS

This application claims priority under 35 U.S.C. § 119(e) from provisional application No. 60/492,675, filed Aug. 6, 2003. The 60/492,675 provisional application is incorporated by reference herein, in its entirety, for all purposes.

### BACKGROUND OF THE INVENTION

1. Field of the Invention

The present invention relates generally to vehicle security devices and more specifically to vehicle recovery systems and methods.

2. Background Information

Many anti-theft and recovery systems and methods for vehicles are well known. Some methods include a transmission device in the automobile generating signals so that a satellite tracking system can locate a misappropriated vehicle. Another system requires a positive act by the driver of the automobile to occur, otherwise some form of alarm, vehicle disablement or both be initiated.

Some of the alarms are audible, visual or both. Sometimes the wrongful driver is informed that a recovery action, disablement or both will occur in anticipation that the wrongful driver will abandon the misappropriated vehicle.

Some recovery methods invoke initiation of an alarm, disablement or both remotely. This remote action is precipitated after discovery of the misappropriation of the vehicle. Remote invocation requires some type of remote signal to be received by a recovery processor within the vehicle. Typically the receiver is a radio receiver or a mobile phone. The invocation of the remote signal may be done by the vehicle owner or by a recovery service.

Some recovery methods invoke an alarm, a disablement action, or a tracking transmission based on an omission or incorrect action by the driver. This automatic action is precipitated by a processor detecting the starting of the car in deviation of a prescribed method. Detection of the misappropriation of the vehicle by the processor causes some combination of recovery methods to be invoked such as turning on a visual alarm, turning on an audible alarm, disabling the vehicle and/or transmitting a radio signal to allow tracking of the misappropriated vehicle. An audio message may be played in the vehicle cab in conjunction with the other actions.

Some methods are anti-theft devices that disable the vehicle absent some action by the vehicle operator.

Many of these methods and systems are effective. Some are costly. Some require expensive subscriptions to a recovery agency, a tracking system, a mobile phone subscription or other perpetual fee service.

Some of the recovery systems tend to be less efficient, particularly where the public is required to intervene when visual and/or audible alarms occur.

U.S. Pat. No. 5,805,057 issued to Eslaminovin pertains to a remote vehicle disabling and distress indicator system. The indicator system is activated by either an external telephone call or by an internal manual switch. The telephone call is received by a modular telephone stored in the vehicle. In the alternative, the vehicle operator can manually turn on an activation switch. Activation of the indicator system disables the vehicle by deactivating the ignition, closing a fuel valve, etc. The signal also causes a distress sign at the top of the vehicle to be illuminated. Detection of the distress sign requires line of sight viewing of the vehicle. The signal will also turn on a pre-recorded distress message audibly detectable by nearby members of the public. This system to be effective requires voluntary, altruistic intervention by a passer by. A continuing expense for maintaining a modular telephone within the vehicle is encountered.

U.S. Pat. No. 6,150,926 to Flick describes a vehicle security system including an indicator mounted to a window antenna unit. The security system responds to signals from one or more remote user transmitters. The system controller includes an alphanumeric display positioned inside the windshield alerting the user to security conditions. The vehicle's alarm system is armed and failing to receive a correct transmission signal from a user transmitter causes audible (horn) and visual (headlights) to go into an alarm mode. Further, a security controller disables the vehicle, thus preventing theft by an individual not using a correctly coded transmitter. This patent is a preventive theft system and requires an active intervention by a user to disarm the alarm and disabling system.

U.S. Pat. No. 6,392,531 BI to Gabbard teaches a vehicle disabling system employing a global positioning satellite. The satellite is capable of locating the vehicle through GPS tracking. A remote unit transmits a shutdown command via a global positioning satellite to a target vehicle. No alarm or public involvement is used to recover the disabled vehicle.

U.S. Pat. No. 5,969,433 to Maggiora et al. use a central service to monitor vehicles where the vehicles communicate sensor readings via a global positioning system or Teletrac. Upon detection of some out of normal condition, a message is sent to the vehicle to correct the condition. If a “panic” condition is detected, the operator is alerted at his workstation. Under appropriate conditions, the vehicle is disabled. This invention applies primarily to transport fleet operations and is designed to prevent theft from the vehicle and/or hijacking. There is no public involvement in the vehicle recovery.

U.S. Pat. No. 6,069,411 to Charron describes an ignition system that requires the insertion of a mobile phone into the circuitry. If the phone's serial number ESN or IMEI matches the pre-established serial number. If so, the circuitry is closed, allowing the vehicle to operate. If the serial number is not correct, the circuitry remains open and results in disablement of the vehicle. This patent is an example of any number of vehicle anti-theft devices requiring the vehicle operator to actively intervene before the vehicle will operate. Thus, this patent pertains to an anti-theft device and not a recovery device.

Two other patents noted, U.S. Pat. No. 5,708,307 to Iijima et al. and U.S. Pat. No. 6,404,073 B1 to Chiang, teach anti-theft systems. The first uses a transmitter-receiver system to read and transmit the code on an ignition key. Failing to receive a valid code, the motor vehicle is disabled. The latter patent uses oil pressure jacks built into the under carriage of the vehicle. If a valid key code is not detected prior to starting the car, the oil pressure jacks lift the vehicle off of the ground thus preventing the vehicle from being driven away.

What is required is a vehicle recovery system and method that is relatively inexpensive and efficient.

### SUMMARY OF THE INVENTION

It is an object of the present invention to provide a vehicle recovery system and method that is based on a highly detectable alarm not requiring line of sight to the vehicle. A preferred embodiment of the present invention uses a smoke flare as the alarm.

It is another object of the present invention to provide a vehicle recovery system and method that is remotely invoked.

It is still another object of the present invention to provide a vehicle recovery system and method that is remotely invoked with wireless communication utilizing unlicensed radio frequency spectrum.

It is one more object of the present invention to provide a vehicle recovery system and method that can be automatically invoked.

It is still another object of the present invention to provide a vehicle recovery system and method that also disables the vehicle to be recovered.

A further object of the present invention is to provide a vehicle recovery system and method that involves a responsive public. The public is educated to recognize the meaning of the highly detectable smoke flare. Further, the public is encouraged, through an incentive, to report the location of the highly detectable smoke flare source.

It is another object of the present invention to provide a vehicle recovery system and method that detects vehicle speed before disabling the vehicle.

It is yet another object of the present invention to provide a vehicle recovery system and method that detects if the vehicle is in an enclosure before invoking a smoke flare alarm.

The present invention is a method and system that executes a recovery of a misappropriated vehicle by setting off a highly detectable smoke flare. The alarm does not require line of site to the misappropriated vehicle for detection. Recovery, in alternate embodiments, is initiated remotely or automatically. Remote initiation, in an embodiment, is based on wireless communications over unlicensed RF spectrum, thus avoiding the expense of maintaining a mobile phone subscription for the vehicle. Further, other embodiments of the present invention allow for vehicle disablement along with discharge of an alarm. Still other embodiments incorporate sensing vehicle speed and whether the vehicle is in an enclosure before disabling and alarm discharge.

### BRIEF DESCRIPTION OF THE DRAWING

FIG. 1 is a schematic of the present invention.

FIG. 2 is a schematic of the public's involvement along with the recovery service agency in the present invention.

FIG. 3 is an expanded schematic of the Misappropriation Signal and the Alarm Discharge Apparatus.

### DETAILED DESCRIPTION OF THE INVENTION

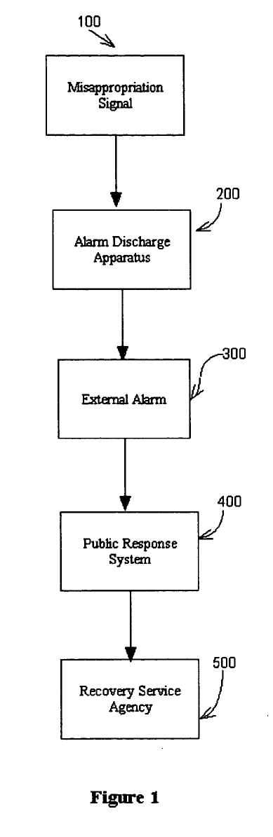

Referring to FIG. 1, a schematic of the present invention, is illustrated. A Misappropriation Signal 100 initiates the vehicle recovery system. In one embodiment of the present invention the misappropriation signal is transmitted from a remote source. In another embodiment of the present invention logic within the vehicle generates an internal recovery signal.

The Alarm Discharge Apparatus 200, an on board processor in one embodiment, implements vehicle recovery once the misappropriation signal 100 is received. A vehicle alarm 300, detectable outside of the vehicle, is discharged. This alarm is detectable beyond line of sight to the vehicle. It may be a loud, audible alarm, a highly detectable visual alarm or some combination. In a preferred embodiment of the present invention, the vehicle alarm is a smoke flare discharged after the flare has been positioned to clear the vehicle.

The Public Response System 400 allows a member of the public having detected the vehicle alarm a means to communicate the alarm detection and approximate location of the vehicle. Incentive to communicate the whereabouts of the vehicle is provided by a public campaign publishing the alarm's description and offering a reward to report the alarm detection. An easily remembered toll free number is provided to the public to ease the communication process.

The Recovery Service Agency 500 directs recovery operations, whether called by a member of the public, a law enforcement agency or a subscriber to the recovery service. Approximate location of the vehicle is

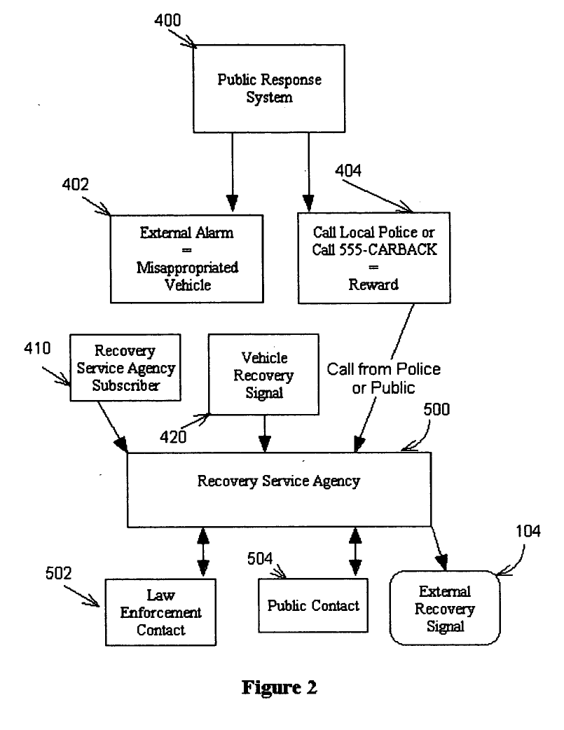

Referring to FIG. 2 the Public Response System 400 and Recovery Service Agency 500 schematic is illustrated in greater detail. Through an education campaign, members of the public are educated as to the meaning of the vehicle alarm. The highly detectable vehicle alarm, which, in a preferred embodiment is a smoke flare, is taught to mean that the vehicle from which it has been discharged is being misappropriated 402. The public is further instructed that an easy communications means 404 is available for reporting the detection of the vehicle alarm. FIG. 2, for example, uses a hypothetical toll free number, 555-CARBACK.

Further, the public is also advised that there is an incentive to make the recovery call, This incentive, in a preferred embodiment is a reward 404. A further advantage is that by calling the Recovery Service Agency 500 an individual does not have to get involved with local law enforcement agencies, although she may opt to so. The police (or other law enforcement agency) may also use the communications means 404 provided to contact the recovery service agency 500.

The recovery service agency 500, in alternative embodiments, receives communications from the public and/or the police 404, a Recovery Service Agency Subscriber 410 and/or an Internal Recovery signal 104 (discussed in more detail infra). The Internal recovery Signal is transmitted from the vehicle itself.

The recovery service agency 500 directs the recovery operations. Upon a reported detection and approximate location of the alarm, a recovery service agency operator contacts a law enforcement agency local to the detection location. In a preferred embodiment, the vehicle has been disabled, thus making recovery easier. Further, in another embodiment of the present invention, the vehicle broadcasts a vehicle recovery signal 420 to the recovery service agency 500.

Transmission of the vehicle recovery signal 420 is made alternatively by a mobile telephone installed in the vehicle, by a radio transmitter using Short Range Radio (SRR) frequencies utilizing radio spectrums in unlicensed bands, or by some combination of the two. The mobile cell phone industry, in its migration to third generation (3G) standards, has begun employing unlicensed radio frequencies to support inexpensive wireless networks. The unlicensed SRR frequencies provide superior data packet wireless transmission and provide support for wireless networking standards IEEE 802.11(a) and (b), and Bluetooth as well as variations thereon.

In a preferred embodiment of the present invention, the Recovery Service Agency 500 is in a wireless data network with vehicles under subscription. This network would allow data transmission between the vehicles and the Recovery Service Agency 500. Since the frequencies used are unlicensed, the subscriber avoids the cost of maintaining a cellular phone in the vehicle. There would be the cost of a transceiver installed in the vehicle and the cost of maintaining a subscription.

In an embodiment of the present invention, a Recovery Service Agency Subscriber 410 contacts the Recovery Service Agency 500 upon discovery that the subscriber's vehicle has been misappropriated. This contact 410 is made by phone, network messaging, or other means. Subscription identifier, password and other information are passed to the Recovery Service Agency 500. In an embodiment of the present invention, a wireless network address for each vehicle is part of the database maintained by the recovery service agency. Using the vehicle's network address, a network wireless transmission is communicated from the agency as an External Recovery Signal 102 to the misappropriated vehicle to initiate recovery actions.

In another embodiment, the external recovery signal 102 is communicated from the recovery service agency 500 to the vehicle by cellular phone transmission. This recital of communications means is not meant to exclude other present and future remote communications technologies.

Additionally, the recovery service agency 500 performs administrative functions such as contact law enforcement agencies 502 and members of the public 504 to dispense any rewards or explanations as required.

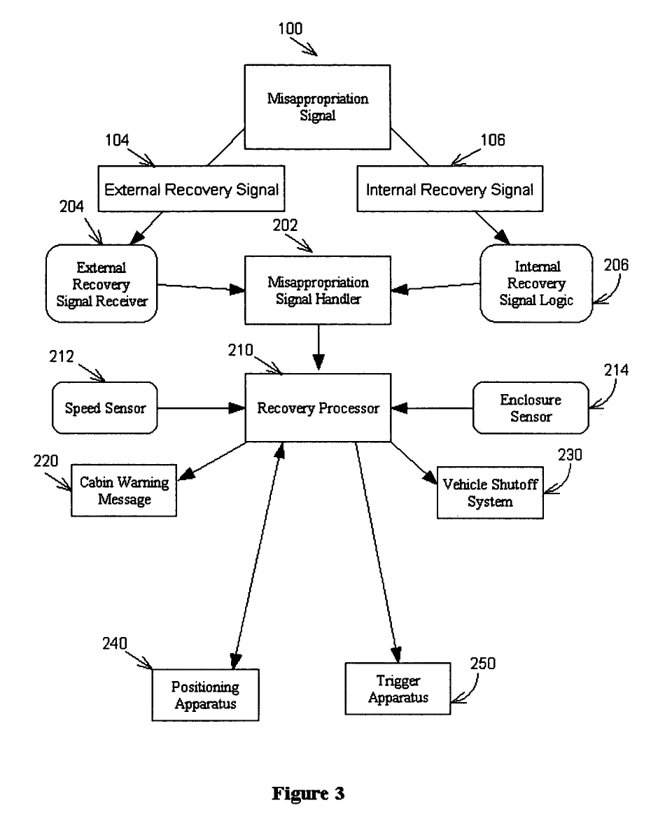

Referring now to FIG. 3, an expanded schematic of the Misappropriation Signal and the Alarm Discharge Apparatus are illustrated. This illustration details the recovery activities performed at the vehicle.

In one embodiment of the present invention, the Misappropriation Signal 100 is initiated external to the vehicle 104 or may be initiated internally 106. A RF receiver 204 receives the external recovery signal 104. As discussed above, the receiver 204 may be a cell phone, a wireless radio receiver operating in the unlicensed spectrum, or any wireless technology capable of completing the data transfer. The initiator of the external recovery signal may be the vehicle owner, the recovery service agency or appropriate law enforcement agency.

The internal recovery signal path 106 is initiated by logic within the vehicle. This logic is programmed to detect when a legitimate operator is not controlling the vehicle. If some action or response is not forthcoming at the beginning or during a trip, the automatic internal recovery signal initiates the recovery process.

The Alarm Discharge Apparatus 200 (from FIG. 1) is in FIG. 3 represented by the elements in the 200 plus range. The Misappropriation Signal Handler 202, an on-board processor, assesses recovery signal information, including pass codes and alternative instructions that may be available. Instructions are then passed to a recovery processor 210. (Note that the misappropriation signal handler 202 and the recovery processor 210 may be combined into an inclusive processor.)

The recovery processor 210 directs the vehicle disabling apparatus 230 to disable the vehicle. The method used by the disabling apparatus 230 may include, but is not limited to, stopping the fuel supply, turning off the electronic ignition and gradually diminishing the fuel supply.

In one embodiment of the present invention, a cabin warning message 220 is played within the vehicle's cabin announcing that the vehicle will be disabled and the driver should come to a stop to avoid danger to the cabin passengers. In another embodiment, the recovery processor 210 utilizes a speed sensor 212 and only disables the vehicle when the speed is sufficiently slow (or the vehicle is stopped).

The vehicle recovery system and method of the present invention involves discharging a highly detectable alarm such that a member of the public is likely to notice and respond. One embodiment uses a smoke flare similar to the type of flare used to signal the position of a ship or boat that is in distress. There are different colored smoke flares available that may be used. A yellow flare, for example, may be discharged to signal the whereabouts of a misappropriated vehicle. One embodiment discharges a smoke flare periodically, thus increasing the likelihood of detection and reaction by the public.

The Recovery Processor 210 in one embodiment of the present invention utilizes an enclosure sensor 214 to determine if the vehicle is within an enclosure. The enclosure sensor 214 is able to detect enclosure by transmitting sonar waves and reading the echo of the transmitted sonar. Other technologies may be employed with similar utility. In an alternative embodiment, some electromotive frequency wave is transmitted and its echo read.

An enclosed vehicle's enclosure sensor 214 will detect a high rate of echoed waves if the vehicle is enclosed. If the vehicle is not enclosed, then the Recovery Processor directs a flare positioning apparatus 240 to position one or more flares in preparation of ignition. Upon feedback from the flare positioning apparatus 240 that a flare is positioned such that the flare's smoke will be unencumbered, the Recovery Processor 210 directs a flare trigger apparatus 250 to ignite the smoke flare.

The Recovery Processor 210 in another embodiment of the present invention relies on the speed sensor 212 before positioning 240 and igniting 250 the flare. In this embodiment, the Recovery Processor 210 detects the vehicle has been proceeding at some driving speed using the speed sensor 212. When the vehicle has slowed sufficiently or stopped, the vehicle shutoff system 220 is engaged, with or without a cabin warning message 220 being played. As the vehicle is disabled, the smoke flare is simultaneous positioned 240 and ignited 250 thus allowing easy reporting as to the vehicle's location by the public.

A vehicle recovery system and method have been described. It will also be understood that the invention may be embodied in other specific forms without departing from the spirit or central characteristics thereof. The present examples and embodiments, therefore, are to be considered in all respects as illustrative and not restrictive, and the invention is not to be limited to the details given herein

1. A vehicle recovery system comprising:
a vehicle alarm detectable external to the vehicle for signaling that the vehicle is being misappropriated;
an alarm discharge apparatus for discharging the vehicle alarm;
a misappropriation signal for communicating to the alarm discharge apparatus that the vehicle is being misappropriated;
a public response system for reporting a detection of the vehicle alarm;
and a recovery service agency for directing recovery of the vehicle.

2. The vehicle recovery system of claim 1 wherein the alarm discharge apparatus comprises:
a recovery processor for implementing a recovery action;
a misappropriation signal handler for processing the misappropriation signal wherein the misappropriation signal handler provides input to the recovery processor; and
a trigger apparatus for triggering the vehicle alarm wherein the recovery processor activates the trigger apparatus thus discharging the vehicle alarm.

3. The vehicle recovery system of claim 2 wherein the misappropriation signal handler comprises a receiver for receiving an external recovery signal.

4. The vehicle recovery system of claim 3 wherein the external recovery signal receiver is a radio receiver operating in unlicensed frequency spectrum.

5. The vehicle recovery system of claim 2 wherein the misappropriation signal handler comprises logic for generating an internal recovery signal.

6. The vehicle recovery system of claim 2 wherein the recovery processor further comprises a vehicle shutoff system for disabling the vehicle whereby the vehicle shutoff system disables the vehicle close in time to discharging the vehicle alarm.

7. The vehicle recovery system of claim 6 wherein the recovery processor further comprises a speed sensor for detecting the vehicle's speed whereby the vehicle shutoff system will only operate when the vehicle's speed is below some predetermined speed.

8. The vehicle recovery system of claim 1 wherein the public response system comprises:
a means for reporting an observance of the vehicle alarm and
an incentive for encouraging a member of the public for reporting the approximate location of the vehicle alarm.

9. A vehicle recovery system comprising:
a vehicle alarm detectable external to the vehicle for signaling that the vehicle is being misappropriated wherein the vehicle alarm is a smoke flare;
an alarm discharge apparatus for discharging the smoke flare;
a misappropriation signal for communicating to the alarm discharge apparatus that the vehicle is being misappropriated;
a public response system for reporting a detection of the smoke flare; and a recovery service agency for directing recovery of the vehicle.

10. The vehicle recovery system of claim 9 wherein the alarm discharge apparatus comprises:
a misappropriation signal handler for processing a recovery required signal;
a recovery processor for implementing a recovery action;
a positioning apparatus for positioning the smoke flare; and
a trigger apparatus for igniting the smoke flare wherein the recovery processor activates the trigger apparatus thus discharging the smoke flare.

11. The vehicle recovery system of claim 10 wherein the misappropriation signal handler further comprising a receiver for receiving an external recovery signal.

12. The vehicle recovery system of claim 11 wherein the external recovery signal receiver is a radio receiver operating in unlicensed frequency spectrum.

13. The vehicle recovery system of claim 10 wherein the misappropriation signal handler further comprising logic for generating an internal recovery signal.

14. The vehicle recovery system of claim 10 further comprising a vehicle shutoff system for disabling the vehicle whereby the vehicle shutoff system disables the vehicle close in time to discharging the smoke flare.

15. The vehicle recovery system of claim 14 further comprising a speed sensor for detecting the vehicle's speed whereby the vehicle shutoff system will only operate when the vehicle's speed is below some predetermined speed.

16. The vehicle recovery system of claim 10 further comprising an enclosure sensor for detecting whether the vehicle is enclosed whereby the smoke flare will be discharged only if the vehicle is not enclosed.

17. The vehicle recovery system of claim 9 wherein the public response system comprises:
a means for reporting an observance of the smoke flare and
an incentive for encouraging a member of the public for reporting the approximate location of the smoke flare.

18. A vehicle recovery method comprising:
discharging a vehicle alarm for signaling that a vehicle is being misappropriated, said vehicle alarm being highly detectable from outside the vehicle wherein detection of the vehicle alarm does not require line of sight to the vehicle;
educating the public that there is an incentive to reporting a detection of the vehicle alarm;
providing a communications means to a recovery service agency for reporting the detection of the vehicle alarm; and
the recovery service agency coordinating the recovery of the vehicle.

19. The vehicle recovery method of claim 18 wherein the vehicle alarm is a smoke flare.

20. The vehicle recovery method of claim 18 further comprising the vehicle transmitting a signal to the recovery service agency indicating that the vehicle is being misappropriated.

21. The vehicle recovery method of claim 18 further comprising a recovery service agency subscriber communicating to the recovery service agency that a recovery service agency subscriber's vehicle has been misappropriated.

22. The vehicle recovery method of claim 18 further comprising the recovery service agency transmitting an external recovery signal to the vehicle.
